(19) United States
(12) Patent Application Publication
(10) Pub. No.: US 2017/0240845 A1
(43) Pub. Date: Aug. 24, 2017

(54) Laundry Detergent Composition with Vinegar

(71) Applicant: Tonya Harris, Garden Ridge, TX (US)

(72) Inventor: Tonya Harris, Garden Ridge, TX (US)

(21) Appl. No.: 15/046,546

(22) Filed: Feb. 18, 2016

(51) Int. Cl. C11D 3/20; B65D 1/02; B65D 23/10; C11D 11/00

(52) U.S. Cl. CPC C11D 3/2079; C11D 11/0017; B65D 1/02; B65D 23/102

(57) ABSTRACT

A laundry detergent composition with vinegar removes stains and odors from laundry. The composition is provided as a liquid in a plastic bottle. Vinegar is provided as part of the composition, and will gently and effectively remove stubborn stains and odors from laundry. The composition is color-safe and biodegradable.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to laundry aids and in particular to a laundry detergent composition with vinegar. Concerns about detergent enzymes and their effects on the environment have influenced a new way of thinking in the research and development of laundry aids. Natural fruit, vegetable, and even grain products are being investigated for their ability to gently and effectively remove dirt, stains, and odors, then quickly break down into simple, non-toxic compounds.

A search of the prior art reveals various biodegradable detergents which have been developed to launder clothes and linens. None are closely related to the present invention, but several include features which resemble those of the present invention. Each has proven to be less than satisfactory in its own way. The present invention has been developed for the purpose of addressing and resolving these disadvantages.

All purpose cleaner containing D-Limonene, U.S. Pat. No. 4,620,937 (filed Feb. 11, 1985), provides a cleaning agent for use as an industrial heavy duty cleaner, as well as a hand cleaner and an all purpose cleaner. The cleaning agent has citric oil as its basic ingredient, and preferably includes a distilled, stabilized citric oil mixture including distilled D-Limonene, stearic and oleic acids, and a non-ionic detergent. Additionally, aloe vera juice and/or vinegar can also be included in the cleaning agent.

Natural laundry detergent compositions, U.S. Pat. No. 7,638,474 (filed Aug. 5, 2008), provides a laundry detergent composition with a limited number of natural ingredients containing a hydrogen peroxide source, sodium carbonate and a surfactant selected from a fatty alcohol sulfate, alkyl polyglucoside and a lauryl sarcosinate. The laundry composition optionally has a fragrance, colored speckles, builder and enzymes. The laundry detergent composition can be used to clean tough stains on fabrics and cleans as well or better than commercial compositions containing synthetically derived cleaning agents.

Liquid laundry detergent-bleach composition and method of use, U.S. Pat. No. 4,786,431 (priority Dec. 31, 1984), provides a liquid laundry detergent composition containing a perborate bleach. Hydroxylamine sulfate is added as a bleach stabilizer and specifically as an inhibitor of catalase, an enzyme present in natural body soils, which enzyme will rapidly decompose hydrogen peroxide, the active bleaching component of the perborate bleach. The preferred compositions are non-aqueous liquids based on liquid nonionic surfactants and preferably include a detergent builder salt suspended in the liquid nonionic surfactant.

Bacteriostatic and disinfectant laundry detergent, Chinese Patent No. CN102766537-(filed Jul. 17, 2012), provides a bacteriostatic and disinfectant laundry detergent which comprises the following components in parts by weight: 12-18 parts of sodium lauryl ether sulfate, 3-8 parts of coconut diethanolamide, 5-10 parts of surfactant, 7-10 parts of cationic conditioner, 15-25 parts of sodium perborate, 18-28 parts of sodium carbonate, 0.2-2 parts of tea tree oil, 0.01-0.5 part of mature vinegar, 0.1-0.8 part of chamomile extracts, and the balance of deionized water. Because natural plant essences are added in the bacteriostatic and disinfectant laundry detergent, the bacteriostatic and disinfectant laundry detergent disclosed by the invention not only can achieve bacteriostatic and disinfectant effects, but also can care for the clothes.

Efficient laundry detergent, Chinese Patent No. CN103540437 (filed Oct. 9, 2013), provides a mild and efficient laundry detergent which consists of laccase, fatty alcohol-polyoxyethylene ether, sldium lauryl sulfate, sodium citrate, sodium dodecylbenzene sulfonate, menthyl acetate, sodium perborate, tea tree oil, mature vinegar and camomille extract. The laundry detergent disclosed by the invention is environment-friendly in component, strong in detergency, and free from damages to clothes; fresh fragrance is remained on the clothes washed by the laundry detergent by virtue of the added tea tree oil and the camomille, and therefore, the efficient laundry detergent is a washing product with extensive application prospect.

Water-saving laundry detergent, Chinese Patent No. CN104830565 (filed Apr. 29, 2015), provides a water-saving laundry detergent which is composed of the following raw materials in parts by weight: 2 to 6 parts of methanol, 1 to 3 parts of sodium carbonate, 5 to 8 parts of sodium sulfonate, 1 to 5 parts of succinic acid, 6 to 9 parts of dodecyl dimethyl amine oxide, 2 to 6 parts of essence, 1 to 5 parts of sodium linear alkyl benzene sulfonate, 2 to 6 parts of kumquat extract, 2 to 5 parts of hydrolytic protease, 4 to 6 parts of fluorescent whitening agent, 2 to 6 parts of benzene sulfonic acid, 1 to 3 parts of sodium hydroxide, 5 to 15 parts of water, 8 to 14 parts of sulfonic acid, 1 to 3 parts of sodium perborate, and 1 to 2 parts of mature vinegar. The provided water-saving laundry detergent has the advantages of strong dirt-removing ability, low foam, rapidness in rinsing, and water saving.

Most of these inventions provide additional active ingredients in addition to vinegar. This creates a disadvantage by complicating the manufacturing process, increasing cost, and reducing biodegradability. A laundry detergent composition with vinegar, which gently removes stains and odors from white and colored laundry, would resolve these disadvantages.

### SUMMARY OF THE INVENTION

Accordingly, the invention is directed to a laundry detergent composition with vinegar. The composition is provided as a liquid in a plastic bottle. Vinegar is provided as part of the composition, and will gently and effectively remove stubborn stains and odors from laundry. The composition is color-safe and biodegradable.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the bottle 10, and the cap 11.

FIG. 2 provides front, side, and rear views of the first exemplary embodiment, displaying the bottle 10, the handle 10A, the cap 11, and the label 12.

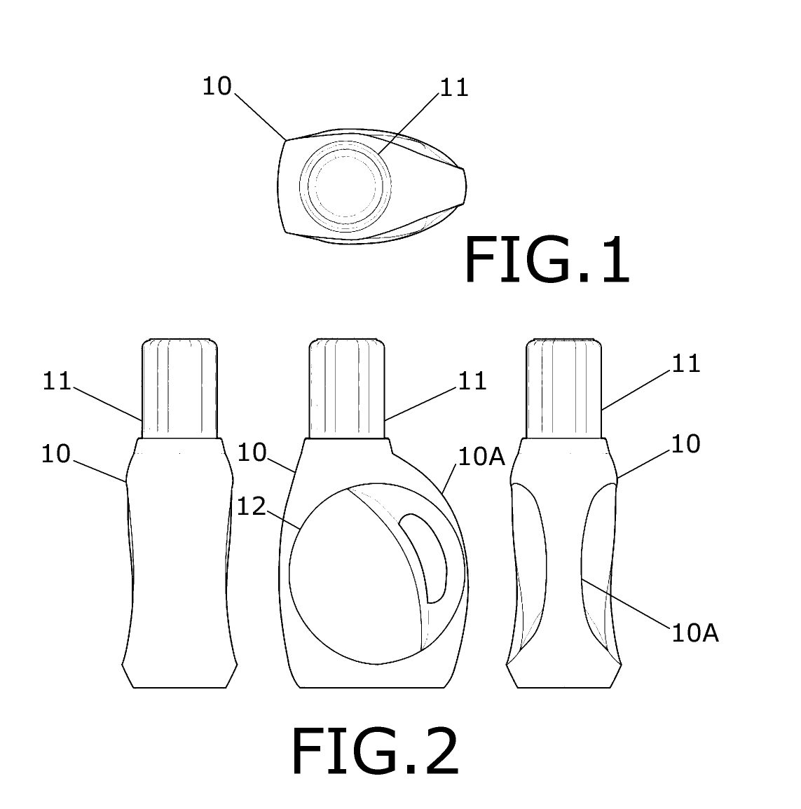

### DETAILED DESCRIPTION OF THE INVENTION

Referring now to the invention in more detail, the invention is directed to a laundry detergent composition with vinegar. The composition is formulated by combining one cup (8 fluid ounces) vinegar, preferably a white vinegar composition, with 8 cups (64 fluid ounces) of a chemically standard commercially available liquid laundry detergent (of a concentration formulated for standard washing machines as opposed to high efficiency washing machines). More generally, the vinegar and detergent may be combined in a ratio of 1:8.

The first exemplary embodiment is comprised of a laundry detergent composition, provided as a liquid in a plastic bottle 10. The bottle 10 provides a built-in handle 10A on the rear surface, a large, threaded cap 11 on the top surface which may be used for measurement, and labels 12 on the side surfaces. Vinegar is provided as part of the composition, and will gently and effectively remove stubborn stains and odors from laundry. The composition is color-safe and biodegradable.

Vinegar neutralizes odors rather than just covering them up. Vinegar has an acidic pH (3.0) which causes a chemical change in the odorous compound. This chemical change also weakens the chemical bond of the compound to the fabric. Common odors come from compounds that are either acidic or alkaline, which vinegar balances by changing pH levels in the chemical structure of odor-causing alkalines, bringing them closer to neutral.

To use the first exemplary embodiment, the user removes the cap 11 from the bottle 10, and pours a portion of the composition from the bottle 10 into the cap 11 to measure it. The user then pours the composition from the cap 11 into the user's clothes washer.

The bottle 10 and the cap 11 are preferably manufactured from a semi-rigid, durable material, such as plastic. The labels 12 are preferably manufactured from a flexible, disposable material, such as paper. The laundry detergent composition is preferably manufactured from biodegradable compounds including vinegar, zeolites, and linear alkylbenzene sulfonates.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A laundry detergent composition, comprising vinegar; a chemically standard commercially available liquid laundry detergent; said vinegar and said chemically standard commercially available liquid laundry detergent being in a ratio of 1:8.

2. The laundry detergent composition of claim 1, wherein said vinegar is a white vinegar composition.

3. The laundry detergent composition of claim 1, wherein said chemically standard commercially available liquid laundry detergent is of a concentration formulated for a standard washing machine and not of a concentration formulated for a high efficiency washing machine.

4. The laundry detergent composition of claim 1, wherein the composition is provided as a liquid in a plastic bottle.

5. The laundry detergent composition of claim 2, wherein the composition is provided as a liquid in a plastic bottle.

6. The laundry detergent composition of claim 3, wherein the composition is provided as a liquid in a plastic bottle.

7. The laundry detergent composition of claim 4, wherein the bottle provides a built-in handle on a rear surface, a large, threaded cap on a top surface, and a one or more labels on at least one side surface.

8. The laundry detergent composition of claim 5, wherein the bottle provides a built-in handle on a rear surface, a large, threaded cap on a top surface, and a one or more labels on at least one side surface.

9. The laundry detergent composition of claim 6, wherein the bottle provides a built-in handle on a rear surface, a large, threaded cap on a top surface, and a one or more labels on at least one side surface.

10. The laundry detergent composition of claim 1, wherein the composition is color-safe and biodegradable.

11. The laundry detergent composition of claim 1, wherein a chemical change in an odorous compound or a plurality of odorous compounds present in soiled fabrics is caused by the vinegar's acidic pH.

12. The laundry detergent composition of claim 7, wherein the cap is removed from the bottle, a portion of the composition is poured from the bottle into the cap to measure it, and the composition from the cap is poured into a washing machine.

13. The laundry detergent composition of claim 7, wherein the bottle and the cap are preferably manufactured from a semi-rigid, durable material, such as plastic, and the labels are preferably manufactured from a flexible, disposable material, such as paper.

14. The laundry detergent composition of claim 8, wherein the cap is removed from the bottle, a portion of the composition is poured from the bottle into the cap to measure it, and the composition from the cap is poured into a washing machine.

15. The laundry detergent composition of claim 8, wherein the bottle and the cap are preferably manufactured from a semi-rigid, durable material, such as plastic, and the labels are preferably manufactured from a flexible, disposable material, such as paper.

16. The laundry detergent composition of claim 9, wherein the cap is removed from the bottle, a portion of the composition is poured from the bottle into the cap to measure it, and the composition from the cap is poured into a washing machine.

17. The laundry detergent composition of claim 9, wherein the bottle and the cap are preferably manufactured from a semi-rigid, durable material, such as plastic, and the labels are preferably manufactured from a flexible, disposable material, such as paper.

18. The laundry detergent composition of claim 1, wherein the laundry detergent composition is preferably manufactured from biodegradable compounds including vinegar, zeolites, and linear alkylbenzene sulfonates.
